(19) United States
(12) Patent Application Publication
(10) Pub. No.: US 2014/0029013 A1
(43) Pub. Date: Jan. 30, 2014

(54) OPTICAL COHERENCE TOMOGRAPHIC IMAGING APPARATUS

(71) Applicant: CANON KABUSHIKI KAISHA, Tokyo (JP)

(72) Inventors: Minoru Yoshii, Tokyo (JP); Eiichi Fujii, Kamakura-shi (JP); Tomohiro Yamada, Yokohama-shi (JP); Takefumi Ota, Tucson, AZ (US)

(21) Appl. No.: 13/947,795

(22) Filed: Jul. 22, 2013

(30) Foreign Application Priority Data
Jul. 24, 2012 (JP) 2012-163548

(51) Int. Cl. G01B 9/02

(52) U.S. Cl. CPC G01B 9/02091
USPC 356/479

(57) ABSTRACT

An optical coherence tomographic imaging apparatus includes a wavelength-sweeping light source. The wavelength-sweeping light source includes an optical resonator in which a light amplifying medium and a dispersive element configured to give angular dispersion to light emitted from the light amplifying medium according to the wavelength are provided, and a wavelength selection element having a rotating mechanism. An arithmetic processing unit converts a selected wavelength obtained in correspondence with a rotation angle of the rotating mechanism into an optical frequency, and obtains a data string of interfering signals at equal optical frequency intervals by interpolation on the basis of data on interfering signals sampled in correspondence with the rotation angle.

### BACKGROUND OF THE INVENTION

1. Field of the Invention

The present invention relates to an optical coherence tomographic imaging apparatus using a light source device that can change the oscillation wavelength (oscillation frequency).

2. Description of the Related Art

Optical coherence tomography (hereinafter also abbreviated as OCT) takes a tomographic image of a test body by low coherence light interference. Researches on this imaging technique have recently been energetically conducted in the medical field because the technique can provide a micron-order spatial resolution and is non-invasive.

At present, OCT can obtain tomographic images of several millimeters in depth with resolutions of several micrometers in the depth direction. Thus, applications of OCT to ophthalmic imaging, dermatological imaging, and dental imaging are presently being studied.

A swept source optical coherence tomography (SS-OCT) apparatus temporally sweeps the oscillation wavelength (frequency) of a light source, and is categorized into a Fourier domain (FD)-OCT apparatus.

A spectrum domain (SD)-OCT apparatus, which is also categorized into the FD-OCT apparatus, requires a spectroscope that separates interfering light, whereas the SS-OCT apparatus does not require the spectroscope. Therefore, the SS-OCT apparatus causes little loss of light and is expected to obtain images with a high signal-to-noise (S/N) ratio.

In SS-OCT, spectral interference appearing in the reflectivity spectrum of an object to be measured is analyzed to obtain depth information about the object.

More specifically, depth information about the object to be measured is calculated by subjecting obtained spectral interfering signals to Fourier transform processing. In contrast, in a wavelength tunable laser light source, the wavelength changes with respect to time in a substantially linear form or a sine wave form. However, obtained data is subjected to Fourier transform processing in the OCT imaging apparatus and the like.

In this case, the wavelength is not used, but the optical frequency is used as a variable. Therefore, there is a demand for a wavelength tunable laser light source in which the optical frequency changes with respect to time in a linear form.

PCT Japanese Translation Patent Publication No. 2011-523460 (hereinafter referred to as Patent Document 1) discloses a method for adopting a lot of measuring points at equal frequency intervals in one wavelength sweep.

Patent Document 1 describes that it is useful for

Fourier transform processing to generate timing signals (k (wavenumber)-trigger signals), and discloses an OCT apparatus in which k-trigger signals are generated at equal frequency intervals of light from a wavelength-sweeping light source, and interfering signals are obtained in correspondence with the timing of the k-trigger signals and are subjected to Fourier transform processing.

In contrast, PCT Japanese Translation Patent Publication No. 2010-517080 (hereinafter referred to as Patent Document 2) discloses a technique in which curved patterns are provided on a rotating disk so that the frequency of light changes in a linear form in proportion to time in one wavelength sweep performed while the rotating disk is rotating at constant speed.

### SUMMARY OF THE INVENTION

In the OCT apparatus disclosed in Patent Document 1, a tomographic image is formed by subjecting beat signals, which are obtained from interfering signals on the basis of the timing signals (k (wavenumber)-trigger signals), to Fourier transform processing.

This apparatus uses a wavelength-scanning light source of an external resonator type using a Fabry-Perot interferometer as a wavelength selection filter.

Part of light from this light source is separated and guided to a Fabry-Perot etalon, trigger signals are generated, and k-trigger signals are generated on the basis of the trigger signals.

However, in the method for generating trigger signals in the etalon, the light source needs to be oscillating, and trigger signals cannot be generated prior to one wavelength sweep. Hence, timing deviation is apt to occur.

In the technique disclosed in Patent Document 2, when a lot of curved patterns are uniformly arranged on the rotating disk, the defective fraction may be increased by exposure nonuniformity and processing nonuniformity, and there is a fear that the apparatus will become expensive.

The present invention provides an inexpensive optical coherence tomographic imaging apparatus that can stably obtain an image with a high S/N ratio by generating interfering signals at equal optical frequency intervals from interfering signals sampled at unequal optical frequency intervals for one sweep.

An optical coherence tomographic imaging apparatus according to an aspect of the present invention includes a light source unit having a wavelength-sweeping light source configured to periodically change an oscillation wavelength of light, an interference optical system configured to separate the light emitted from the light source unit into irradiation light for a test body and reference light and to generate interfering light between reflected light from the test body and the reference light, a photo-detecting unit configured to detect an interfering signal of the interfering light, and an arithmetic processing unit configured to obtain a tomographic image of the test body on the basis of an intensity of the interfering signal detected by the photo-detecting unit. The wavelength-sweeping light source includes an optical resonator in which a light amplifying medium and a dispersive element configured to provide angular dispersion to light emitted from the light amplifying medium according to a wavelength are provided, and a wavelength selection element having a rotating mechanism. The arithmetic processing unit converts a selected wavelength obtained in correspondence with a rotation angle Φ of the rotating mechanism into an optical frequency ω, and obtains a data string of interfering signals at equal optical frequency intervals by interpolation on the basis of data on the interfering signals sampled in correspondence with the rotation angle Φ.

The optical coherence tomographic imaging apparatus according to the aspect of the present invention performs signal processing for conversion into the optical frequency from the rotation angle of the rotating wavelength selection element, and obtains a data string of interfering signals at equal optical frequency intervals by interpolation. This allows an excellent tomographic image with a high S/N ratio to be stably obtained at low cost.

Further features of the present invention will become apparent from the following description of exemplary embodiments with reference to the attached drawings.

### BRIEF DESCRIPTION OF THE DRAWINGS

FIG. 1 illustrates an imaging apparatus according to a representative embodiment of the present invention.

FIG. 2 illustrates a wavelength selection element applicable to an imaging apparatus according to a first embodiment of the present invention.

FIG. 3 demonstrates the principle of a dispersive element applied to the present invention.

FIG. 4 demonstrates the principle of a wavelength selection element applied to the present invention.

FIG. 5 schematically illustrates a light beam subjected to wavelength dispersion by the dispersive element in the present invention.

FIG. 6 schematically illustrates a wavelength selection element using a rotating disk applicable to the present invention.

FIG. 7 is a flowchart of an imaging procedure using the apparatus of the present invention.

FIG. 8 illustrates an imaging apparatus according to a second embodiment of the present invention.

FIG. 9 illustrates an imaging apparatus according to a third embodiment of the present invention.

FIG. 10 illustrates an imaging apparatus according to a fourth embodiment of the present invention.

FIG. 11 demonstrates the relationship between wavelength selection and the optical frequency in the fourth embodiment.

FIG. 12 illustrates an imaging apparatus according to a fifth embodiment of the present invention.

### DESCRIPTION OF THE EMBODIMENTS

Embodiments of the present invention will be described below with reference to the drawings.

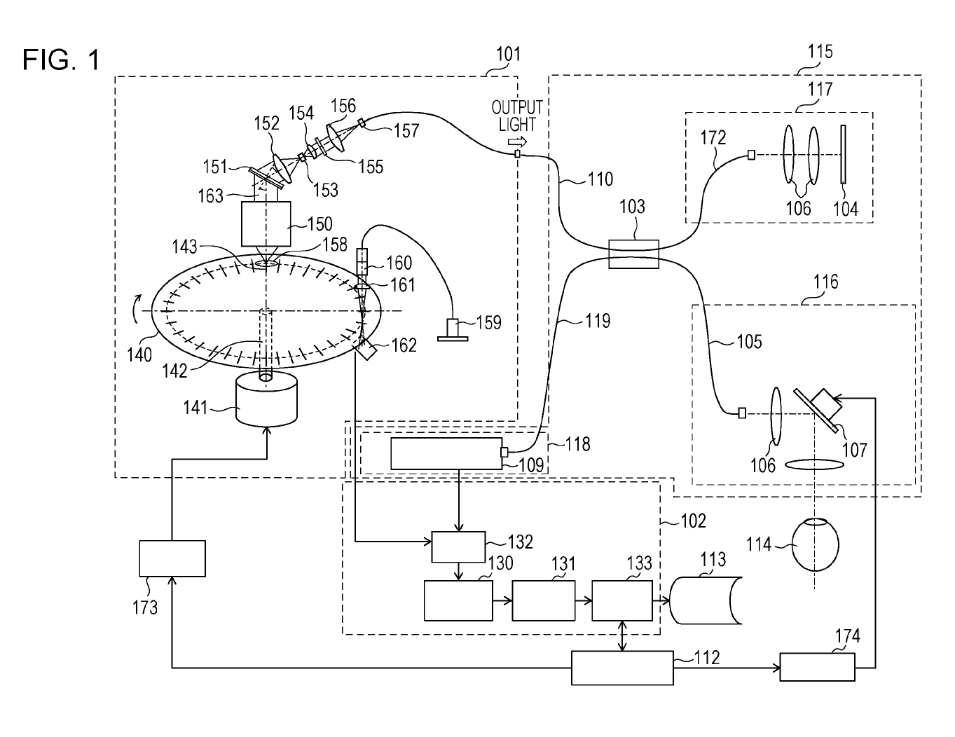

FIG. 1 schematically illustrates an imaging apparatus according to an embodiment of the present invention.

Referring to FIG. 1, a light source unit 101 includes a wavelength-sweeping light source that periodically changes the oscillation wavelength of light.

In the wavelength-sweeping light source included in the light source unit 101 illustrated in FIG. 1, an optical amplifying medium 153 and a diffraction grating 151 serving as a dispersive element, which gives angular dispersion to light emitted from the optical amplifying medium 153 according to the wavelength, are provided between inner sides of a half mirror 155 and a plurality of slit-shaped reflective members 143 that form an optical resonator.

The slit-shaped reflective members 143 are arranged on a circumference of a rotating disk 140 at an equal distance from the rotation center, and constitute a wavelength selection element having a rotating mechanism.

Such a wavelength selection element in which slit-shaped reflective members are provided on a rotating disk is also referred to as a rotating disk patterned reflecting slits.

The light source unit 101 is connected to an interference optical system 115 that separates light emitted from the light source unit 101 via an optical fiber 110 into irradiation light for a test body 114 and reference light and that produces interfering light between reflected light from the test body 114 and the reference light.

In the interference optical system 115, a measurement unit 116 including an optical fiber 105, a condenser lens 106, and an optical scanning mirror 107 is connected via an optical coupler 103 to a reference unit 117 including an optical fiber 172, a reflecting mirror 104, etc. and configured to emit reference light. In the optical coupler 103, interfering light between the reflected light from the test body 114 and the reference light is produced.

Referring to FIG. 1, a photo-detecting unit 118 includes an optical fiber 119 and a photodetector 109. The photo-detecting unit 118 is connected to the optical coupler 103 included in the interference optical system 115, and detects interfering signals that are generated by the measurement unit 116 and the reference unit 117 to form an optical tomographic image.

A signal processing unit 102 performs signal processing to obtain a tomographic image of the test body 114 by subjecting the interfering signals detected by the photo-detecting unit 118 to Fourier transform processing after data processing of the present invention. That is, the signal processing unit 102 serves as an arithmetic processing unit that obtains a tomographic image of the test body 114 on the basis of the intensities of the interfering signals detected by the photo-detecting unit 118.

The signal processing unit 102 is generally formed by a computer such as a personal computer (PC). A display device 113 displays the tomographic image formed by the signal processing unit 102, and is formed by a display for the PC.

In FIG. 1, the signal processing unit 102 includes functional portions 130, 131, and 132 that characterize the present invention. The storage functional portion 132 stores interfering signals, the processing functional portion 130 converts the interfering signals into optical frequencies on the basis of the rotation angle of the wavelength selection element, and the processing functional portion 131 obtains interference data at equal wavenumber intervals by interpolation.

A signal processing portion 133 serves to obtain a tomographic image, for example, by Fourier transform processing.

Interfering signals on which an optical tomographic image is based are sampled at equal time intervals by wavelength sweeping with a constant-speed rotating mechanism (motor) 141.

Trigger signals are used to specify the wavelengths of these series of wavelength swept interfering signals.

A light source 159 generates trigger signals, and condenser lenses 160 and 161 each collect and apply a light beam to the patterns on the rotating disk patterned reflecting slits (rotating disk) 140. Reference numeral 162 denotes a photodetector. The photodetector 162 detects ON/OFF signals to be trigger signals when the reflective members 143 pass thereabove.

One trigger signal is output in every one wavelength sweep. The output timing of the trigger signal is stored in the storage functional portion 132 together with sampled interfering signals for an optical tomographic image.

The rotation angle Φ of the slit mirrors (slit-shaped reflective members) 143 is found from the preset rotation speed of the rotating mechanism 141 and the timing of the trigger signal. The wavelengths λ of the interfering signals sampled at the position of the rotation angle Φ are converted into optical frequencies ω.

It is one of the characteristics of the present invention to obtain data on wavelength swept interfering signals sampled at equal time intervals and optical frequencies corresponding thereto.

In this embodiment, the position of a trigger pattern shares a track of the slit mirrors (slit-shaped reflective members) 143 on the rotating disk 140.

Since the slit mirrors 143 are arranged on the rotating disk 140 at equal angular intervals, it is not always necessary to emit a trigger signal at a slit mirror that is performing wavelength sweeping. As illustrated in FIG. 1, a trigger optical system may be provided at a position apart from a wavelength dispersed beam 158 where it does not cause mechanical interference.

Further alternatively, the trigger pattern may be provided on a different track. In this case, since the rotating disk 140 is rotating at constant speed, one trigger signal may be output every time the rotating disk 140 makes one rotation.

The processing functional portion 131 also characterizes the arithmetic processing unit of the present invention. When data on the wavelength swept interfering signals and the sampled optical frequencies are found by the processing functional portion 130 that converts the interfering signals into the optical frequencies on the basis of the rotation angle of the rotating disk 140, the processing functional portion 131 obtains a data string of interfering signals at equal optical frequency intervals by interpolation.

The above-described functions allow an excellent tomographic image with a high S/N ratio to be stably obtained at low cost.

Other constituents of the light source unit 101 illustrated in FIG. 1 will be briefly described below.

Collimator lenses 152 and 154 are provided on either side of the optical amplifying medium 153 formed, for example, by a semiconductor optical amplification element. After passing through the collimator lens 152, a light beam 163 passes through the diffraction grating 151 and a condenser lens 150, and becomes incident on the rotating disk 140 to form a wavelength dispersed beam 158.

In contrast, a light beam passing through the collimator lens 154 is emitted as laser light from the half mirror 155, passes through a coupling lens 156, and is guided into the optical fiber 110 from a fiber terminal 157.

In the optical coherence tomographic imaging apparatus illustrated in FIG. 1, a control device 112 is connected to the signal processing unit 102. The control device 112 controls a driver 173 connected to the rotating mechanism 141 and a driver 174 for driving the two-dimensional optical scanning mirror 107 in the measurement unit 116.

In the present invention, the arithmetic processing unit can be formed by a personal computer as an example. More specifically, the arithmetic processing unit can be formed by an integrated circuit in which semiconductor elements are integrated, for example, an IC, an LSI, a system LSI, a microprocessing unit (MPU), or a central processing unit (CPU).

In the present invention, examples of an optical amplifying medium for emitting light are an active layer that forms a semiconductor laser, an active layer that forms a semiconductor optical amplifier (SOA), a rare-earth doped (ion doped) optical fiber containing erbium or neodymium, and a medium that performs amplification with dye added in an optical fiber.

As the active layer that forms the semiconductor laser or the semiconductor optical amplifier, a compound semiconductor that forms a typical semiconductor laser can be used. More specifically, an InGaAs, InAsP, GaAlSb, GaAsP, AlGaAs, or GaN compound semiconductor can be used. For example, in these active layers, the center wavelength of gain can be selected from 840, 1060, 1150, 1300, and 1550 nm according to the intended use of the light source.

In the present invention, as the dispersive element for giving angular dispersion to light emitted from the optical amplifying medium according to the wavelength, a diffraction grating (transmissive or reflective), a prism, or a combination of a diffraction grating and a prism can be adopted.

The present invention will be more specifically described below.

### First Embodiment

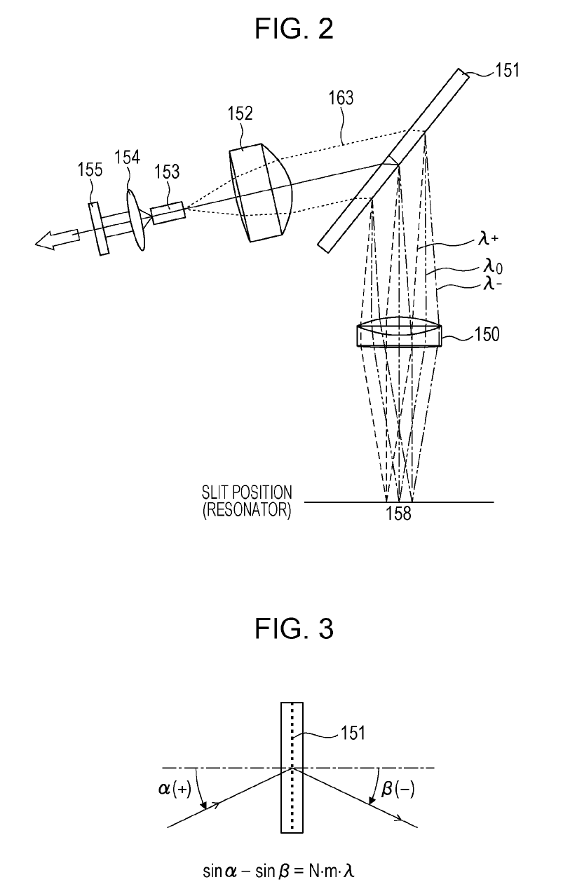

A description will be given of the principle of a frequency-sweeping light source included in a light source unit 101 according to a first embodiment. First, wavelength dispersion by a wavelength dispersing function of a diffraction grating 151 and wavelength selection will be described with reference to FIG. 2.

In the first embodiment, when a rotating disk 140 patterned reflecting slits illustrated in FIG. 1 rotates, slit mirror 143 serving as one mirror of an optical resonator built in the rotating disk 140 selects a light beam with a specific wavelength corresponding to the position of the slit mirror 143 from a wavelength dispersed beam 158 dispersed by the diffraction grating 151.

The light beam with the wavelength selected by the slit mirror 143 is reflected, returns through a condenser lens 150, the diffraction grating 151, and a collimator lens 152, and is amplified by an optical amplifying medium 153.

This light beam further travels, and reaches, via a collimator lens 154, a half mirror 155 having both a function of a resonator and an output function, where it is reflected, reversely traces the path, and returns to the optical amplifying medium 153 again.

By repeating the above operation, the light beam reciprocates in the optical resonator formed by the slit mirror 143 and the half mirror 155, whereby laser oscillation is performed.

Next, when the position of the slit mirror 143 (connected to a spindle motor serving as a rotating mechanism 141 via a spindle shaft 142) moves, a wavelength corresponding to the moved position is selected, and laser oscillation is similarly performed at that wavelength.

When the slit mirrors 143 on the rotating disk 140 rotate and moves in this way, wavelength-swept laser oscillation is performed.

Next, the wavelength distribution of the wavelength dispersed beam 158 will be described.

As illustrated in FIG. 3, the wavelength dispersed beam 158 has a relation given by the following Expression (1) according to the principle of diffraction:

sin α−sin β=Nm λ (1)

where α represents the angle of incident on the diffraction grating, and β represents the emergent angle.

The angle in the counterclockwise direction from the normal to the diffraction grating is a positive angle, and the angle in the clockwise direction is a negative angle. N represents the groove number density in the diffraction grating, and is the reciprocal of the grating pitch. Further, m is a diffraction order of ±1, ±2, . . . . Here, m is set at +1.

When an incident angle α at a reference wavelength λo is fixed to a Bragg diffraction angle (α=−β), it is given by the following Expression (2):

$$α = {sin}^{- 1} ( \frac{{λ}_{0}}{2} N ) \qquad ( 2 )$$

The emergent angle β at a wavelength λ is given by the following Expression (3):

$$β = {sin}^{- 1} ( \frac{{λ}_{0} - 2 \cdot λ}{2} N ) \qquad ( 3 )$$

When the difference in emergent angle between the reference wavelength λo and the wavelength λ is taken as Δβ, it is understood that Δβ is given by the following Expression (4):

$$Δβ = {sin}^{- 1} ( \frac{{λ}_{0} - 2 \cdot λ}{2} N ) + {sin}^{- 1} ( \frac{{λ}_{0}}{2} N ) \qquad ( 4 )$$

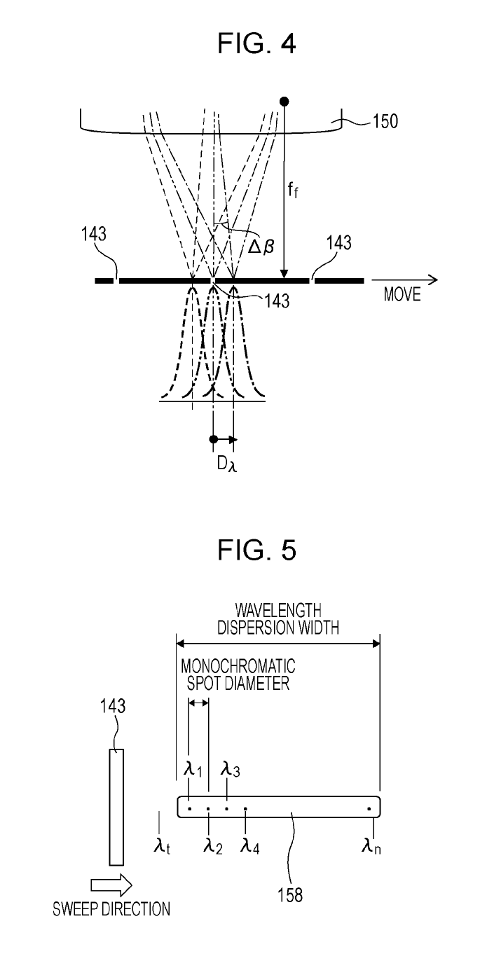

Assuming that the focal length of the condenser lens 150 is taken as f_{f}, as illustrated in FIG. 4, the relationship between the wavelength λ and a position D_{λ} of the wavelength dispersed beam on the rotating disk is given by the following Expression (5) when the position where the light beam with the predetermined reference wavelength λo is incident (impinges) is the origin:

$$\begin{matrix}{D}_{λ} = {f}_{f} \cdot tan Δ β \\ = {f}_{f} \cdot tan ( {sin}^{- 1} ( \frac{{λ}_{0} - 2 \cdot λ}{2} N ) + {sin}^{- 1} ( \frac{{λ}_{0}}{2} N ) )\end{matrix} \qquad ( 5 )$$

Next, the wavelength dispersed beam 158 incident (impinging) on the rotating disk 140 is subjected to wavelength selection at equal intervals because the slit mirror 143 moves at constant speed, as illustrated in FIG. 5.

However, these intervals are not equal wavelength intervals, but have a relation given by Expression (4). In contrast, the relationship between the rotation angle φ of the slit mirror 143 on the rotating disk 140 and the wavelength dispersed beam is given by the following Expression (6), as illustrated in FIG. 4:

D_{λ}=r₀·tan φ (6)

Here, the incident (impinging) position of light with the reference wavelength is the origin of the rotation angle Φ.

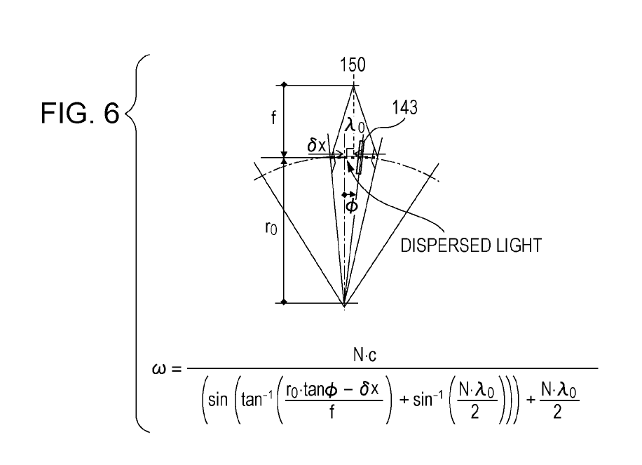

FIG. 6 is a bird's eye view illustrating a plane including the optical axis of the condenser lens and the wavelength dispersed beam, and a surface of the rotating disk 140.

It is known that light output is higher when wavelength sweeping is performed from the short wavelength to the long wavelength than when wavelength sweeping is performed in a reverse manner. Accordingly, the rotation angle has a negative sign when the wavelength is shorter than the reference wavelength, and has a positive sign when the wavelength is longer than the reference wavelength. In this case, the following Expression (7) is obtained using Expressions (5) and (6):

$${f}_{f} \cdot tan ( {sin}^{- 1} ( \frac{{λ}_{0} - 2 \cdot λ}{2} N ) + {sin}^{- 1} ( \frac{{λ}_{0}}{2} N ) ) = - {r}_{0} \cdot tan φ \qquad ( 7 )$$

When Expression (7) is arranged for λ, the following Expression (8) is obtained:

λ=λ₀+Δλ(φ) (8).

Thus, it is understood that the following expression (9) is obtained:

$$Δλ ( φ ) = \frac{1}{N} sin ( {tan}^{- 1} ( \frac{{r}_{0} tan φ}{{f}_{f}} ) + {sin}^{- 1} ( \frac{{λ}_{0}}{2} N ) ) - \frac{{λ}_{0}}{2} \qquad ( 9 )$$

Expression (9) indicates that the selected wavelength λ is determined by detecting the rotation angle Φ of the rotating disk 140.

Here, the relation given by the following Expression (10) is used to convert the wavelength into the optical frequency ω from the rotation angle Φ:

$$\begin{matrix}ω ( φ ) = \frac{c}{λ ( φ )} \\ = \frac{c}{{λ}_{0} + Δλ ( φ )}\end{matrix} \qquad ( 10 )$$

where c represents the light speed.

According to Expression (10), the wavelength is converted into the optical frequency ω from the rotation angle Φ of the wavelength selection element by the processing functional portion 130. Here, λo represents a predetermined reference wavelength, Δλ(Φ) represents the change amount of the oscillation wavelength depending on the rotation angle Φ, and c represents the light speed.

In contrast, since the slit mirror 143 for selecting the wavelength is patterned on the rotating disk 140, the wavelength given by Expression (8) proportional to the angle φ is selected.

Accordingly, when the rotating disk 140 rotates at constant speed, the following Expression (11) is satisfied:

φ(t)=c·t (11)

The angle Φ linearly changes with respect to the time t.

Therefore, when the rotating disk 140 rotates at constant speed and light interfering signals are sampled at equal time intervals, optical tomographic interfering signals are obtained at equal rotation angle intervals.

As shown by Expression (8), (9), or (10), it is understood that light interfering signals sampled at equal time intervals, that is, at equal rotation angle intervals are not sampled at equal wavelength intervals or at equal optical frequency intervals.

However, as described above, light interfering signals sampled at equal optical frequency intervals are necessary to obtain an optical tomographic image (tomographic image) by subjecting the light interfering signals to Fourier transform processing.

Therefore, it is necessary to convert light interfering signals sampled at equal rotation angle intervals, that is, at equal time intervals into light interfering signals sampled at equal optical frequency intervals.

For that purpose, light interfering signals sampled at equal rotation angle intervals (equal time intervals) are temporarily stored in the storage functional portion 132. It is one of the characteristics of the present invention that the rotation angle Φ determined by the equal rotation angle intervals is converted into the optical frequency according to Expression (10).

From the above, light interfering signals sampled at optical frequency intervals are obtained, although the intervals are unequal.

Next, a data string of light interfering signals sampled at equal optical frequency intervals is created from the above-described light interfering signals sampled at the unequal optical frequency intervals.

The data string of light interfering signals is found by data interpolation. Data interpolation is performed by the processing functional portion 131, and is one of the characteristics of the present invention.

A data string of light interfering signals to be sampled at the equal optical frequency intervals is found by interpolation based on the above-described light interfering signal data sampled at the unequal optical frequency intervals.

Thus, the processing functional portion 131 obtains a data string of light interfering signals sampled at equal optical frequency intervals.

This interpolation may be performed by linear interpolation of two points on both sides, or by polynomial interpolation using more points.

As described above, the interfering signals for obtaining an optical tomographic image (tomographic image) are acquired by being sampled at equal time intervals by wavelength sweeping with the constant-speed rotating mechanism 141.

Trigger signals are used to specify the wavelengths (frequencies) of light interfering signals obtained in correspondence with a series of wavelength sweeps.

Trigger signals will be described with reference to FIG. 1.

Referring to FIG. 1, a light source 159 generates a trigger signal, and a condenser lens 160 collects and applies a light beam onto slit mirrors 143 on the rotating disk 140. When the slit mirrors 143 pass, a photodetector 162 detects ON/OFF signals to be trigger signals.

One trigger signal is output in every one wavelength sweep, and the output timing of the trigger signal is stored in the storage functional portion 132 together with the sampling timing of a light interfering signal.

Then, the rotation angle Φ of the slit mirrors 143 is found from the preset rotation speed of the rotation mechanism 141 and the timing of the trigger signal, and a sampled optical frequency is obtained by conversion from the rotation angle φ according to Expression (10).

It is one of the characteristics of the present invention to thus find data on wavelength sweeping interfering signals sampled at equal time intervals and optical frequencies corresponding thereto.

When an optical coherence tomographic image (image) is actually obtained on the basis of light interfering signals sampled in correspondence with trigger signals, it is necessary to initially adjust the relationship between the timing of the trigger signals and the sampling timing of the light interfering signals.

Exemplary initial adjustment will be described below.

The number of sampling points is determined by the depth profiling ability to be obtained, the reference wavelength λo, and the change amount (bandwidth) Δλ of the oscillation wavelength of the wavelength-sweeping light source. Here, the number of sampling points is set at 2048 as an example.

It is assumed that the rotating disk 140 is rotating at constant speed. First, light interfering signals are stored in the storage functional portion 132 at equal time intervals in synchronization with trigger signals. These light interfering signals are sampled at equal rotation angle intervals according to Expression (11).

In this case, when it is assumed that the origin (Φ=0) of the rotation angle Φ for sampling is on the 1024-th point of 2048 points in the storage functional portion 132, since this point corresponds to the position of the reference wavelength λo, it can be converted into an optical frequency according to Expression (10).

In general, in a state in which the timing of the trigger signals and the sampling timing of the light interfering signals are not initially adjusted, even if light interfering signals are acquired at equal time intervals in synchronization with the timing of the trigger signals, there is no guarantee that the 1024-th point corresponds to the position of the reference wavelength λo.

Accordingly, it is necessary to move data on the light interfering signals in the storage functional portion 132 so that the interfering signal of the reference wavelength λo is located at the 1024-th point.

This moving amount can be obtained as follows.

In an initial state in which data on a light interfering signal of the reference wavelength λo is not located on the 1024-th point, first, light interfering signals are converted into light interference signals at equal optical frequency intervals by the processing functional portion 131, as described above, and are subjected to first Fourier transform (FFT) processing by the signal processing portion 133 to obtain an optical tomographic image (image).

At this time, the test body 114 is replaced with a simulation sample having a mirror movable on the optical axis and a depth structure, and the data on the light interfering signals is moved in the storage functional portion 132 so that the layer boundary becomes the sharpest while viewing an optical tomographic image of the simulation sample.

When the layer boundary thus becomes the sharpest, it can be determined that the interfering signal of the reference wavelength λo is located on the 1024-th point.

The moving amount at this time is obtained. By moving subsequent light interfering signals by this moving amount in the storage functional portion 132, it is possible to obtain an optical tomographic image (image) with a high S/N ratio, in which the position of the reference wavelength λo is on the 1024-th point in the storage functional portion 132.

As described above, an optical tomographic image with a high S/N ratio can be obtained by these functional portions that characterize the present invention, that is, the storage functional portion 132 for storing the interfering signals, the processing functional portion 130 for converting the interfering signals into optical frequencies on the basis of the rotation angle of the wavelength selection element, and the processing functional portion 131 for obtaining interfering signal data by interpolation.

When the rotating disk 140 rotates at constant speed, the origin (φ=0) of the rotation angle Φ may be determined while an interfering signal of a predetermined wavelength λt to be a trigger is located near the wavelength dispersed beam 158 instead of the reference wavelength λo.

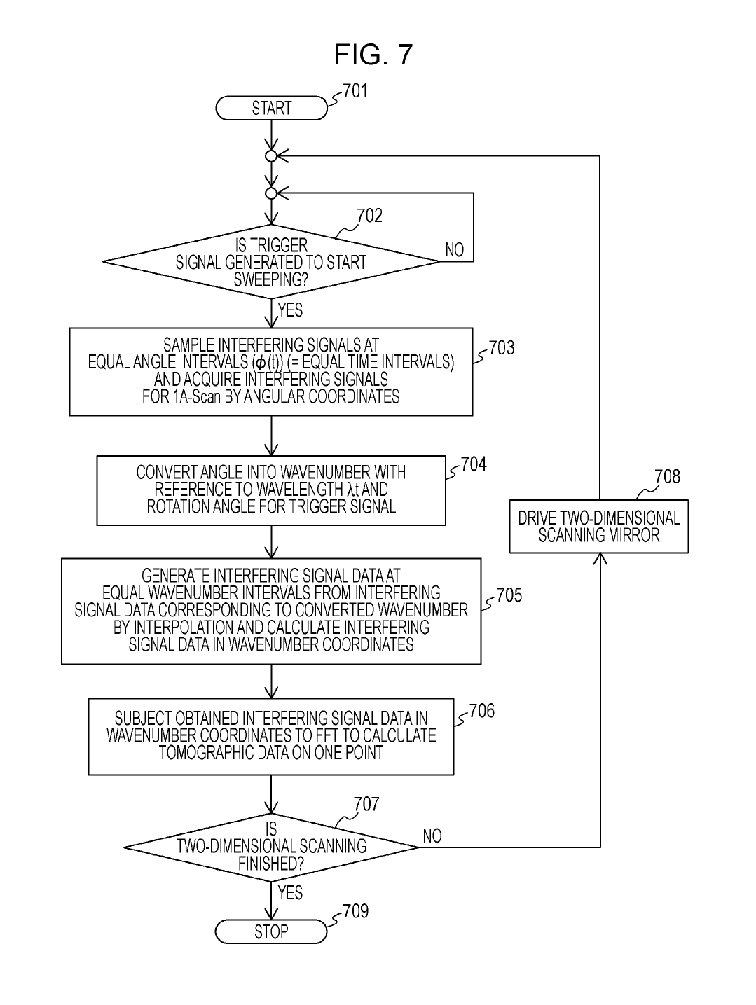

FIG. 7 is a flowchart demonstrating the above-described procedure for obtaining a two-dimensional optical tomographic image (image).

Referring to FIG. 7, the procedure starts in Step 701, and it is determined in Step 702 whether or not a trigger signal is generated to start sweeping.

In Step 703, interfering signals are sampled at equal angle intervals (Φ(t)) to acquire interfering signals for 1Axis-Scan by angular coordinates.

In Step 704, the angle is converted into the wavenumber (optical frequency) with reference to the wavelength λt and the rotation angle corresponding to the trigger signal.

In Step 705, a data string of interfering signals at equal wavenumber intervals is generated from the interfering signal data corresponding to the converted wavenumber by interpolation, and a data string of interfering signals in wavenumber coordinates is calculated.

In Step 706, the obtained data string of interfering signals in the wavenumber coordinates is subjected to Fourier transform processing to calculate tomographic data on one point.

In Step 707, it is determined whether or not two-dimensional scanning is finished.

In Step 708, the two-dimensional scanning mirror is driven.

In Step S709, the procedure is completed.

It is also useful to determine the reference wavelength position by using, as a variable δx, the difference between the incident (impinge) position of the signal of the reference wavelength λo on the rotating disk 140 and the rotation center of the rotating disk 140 perpendicular to the dispersed light beam.

In other words, δx refers to the distance between the incident position of the signal of the predetermined reference wavelength λo on the rotating disk 140 and the position at which the rotation center of the rotating disk 140 is projected in a dispersion direction in which the dispersed light beam is incident.

The following Expression (12) is obtained from the above-described Expression (6):

D_{λ}=r₀·tan φ−δx (12)

For positioning of the reference wavelength λo, it is practically useful to replace the test body 114 with a simulation sample having a mirror movable on the optical axis and a depth structure and to determine δx so that the S/N ratio of the layer boundary of the simulation sample becomes high, while viewing an optical tomographic image of the simulation sample.

The optical frequency in this case is given by the following Expression (13):

$$ω ( φ ) = \frac{c}{{λ}_{0} + Δλ ( φ )} \\ Δλ ( φ ) = \frac{1}{N} sin ( {tan}^{- 1} ( \frac{{r}_{0} tan φ - δ x}{{f}_{f}} ) + {sin}^{- 1} ( \frac{{λ}_{0}}{2} N ) ) - \frac{{λ}_{0}}{2} \qquad ( 13 )$$

where f_{f} represents the focal length of the condenser lens. That is, a change amount Δλ(Φ) of the oscillation wavelength depending on the rotation angle Φ is specified.

Although a tilt error δθy of the rotating disk 140 around the y-axis, which connects the rotation center of the rotating disk 140 and the perpendicular to the dispersed light beam, is conceivable as another error, the correction amount of the optical frequency is negligibly small in actuality.

### Second Embodiment

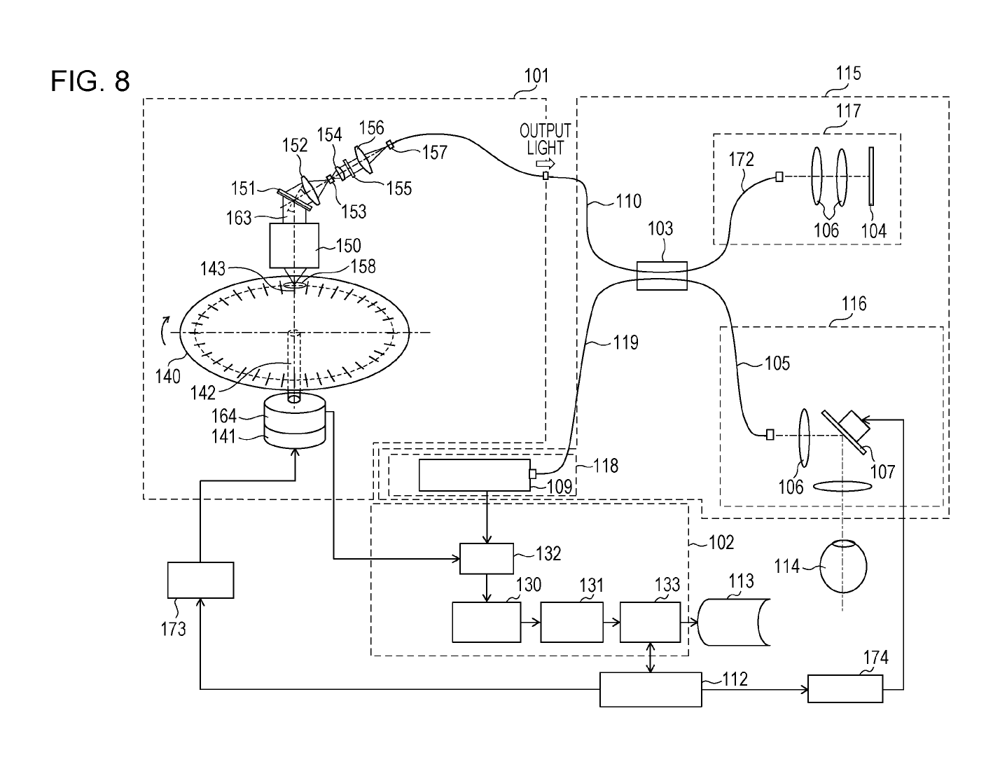

An optical coherence tomographic imaging apparatus according to a second embodiment will be described with reference to FIG. 8.

The optical coherence tomographic imaging apparatus of the second embodiment illustrated in FIG. 8 is different from the apparatus of the first embodiment in that a rotation angle sensor 164 is installed instead of the trigger system for specifying the wavelength position of the light interfering signal.

Since the rotation angle sensor 164 directly detects a rotation angle Φ of a rotating disk 140 patterned reflecting slits, it can accurately perform optical frequency conversion according to Expression (10) or (13).

This method is useful particularly when the rotation of a motor 141 has jitter. This is because the rotation speed changes after the timing of the trigger signal is acquired.

In order to obtain the origin (Φ=0) of the rotation angle, it is practically useful, for positioning of the reference wavelength λo, to replace a test body (object to be measured) 114 with a simulation sample having a mirror movable on the optical axis and a depth structure and to find the initial value of the rotation angle Φ so that S/N ratio becomes high at the layer boundary of the simulation sample while viewing an optical tomographic image of the simulation sample.

### Third Embodiment

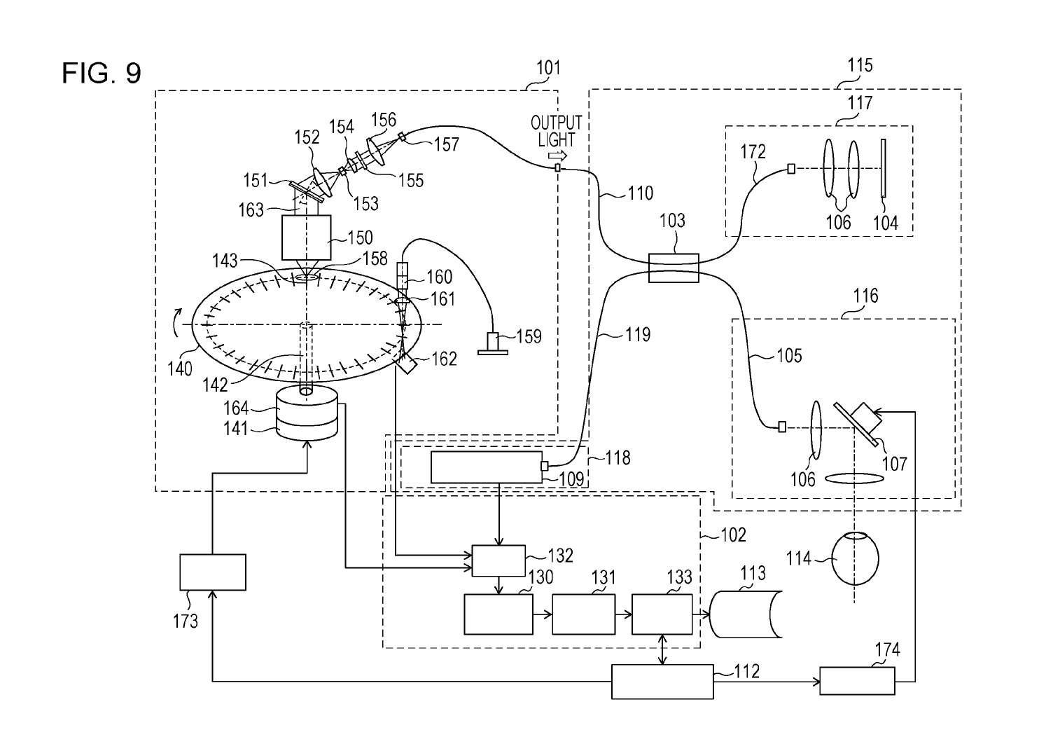

FIG. 9 schematically illustrates an optical coherence tomographic imaging apparatus according to a third embodiment.

The optical coherence tomographic imaging apparatus of the third embodiment is different from the apparatuses of the first and second embodiments in that a trigger system (159, 160, 161, and 162) and a rotation angle sensor 164 are both used to specify the wavelength position of the light interfering signal.

That is, the apparatus of the third embodiment has advantages of both the trigger system and the rotation angle sensor.

When rotation nonuniformity occurs during one rotation of a rotation motor 141, the wavelength position of a light interfering signal can be specified using the latest trigger.

In contrast, when rotation nonuniformity occurs during one rotation of the rotation motor 141, the time interval between one slit mirror 143 and the next slit mirror 143 differs little by little.

In this case, the rotation angle is detected in real time by the rotation angle sensor 164. This allows optical frequency conversion to be accurately performed according to Expression (10).

### Fourth Embodiment

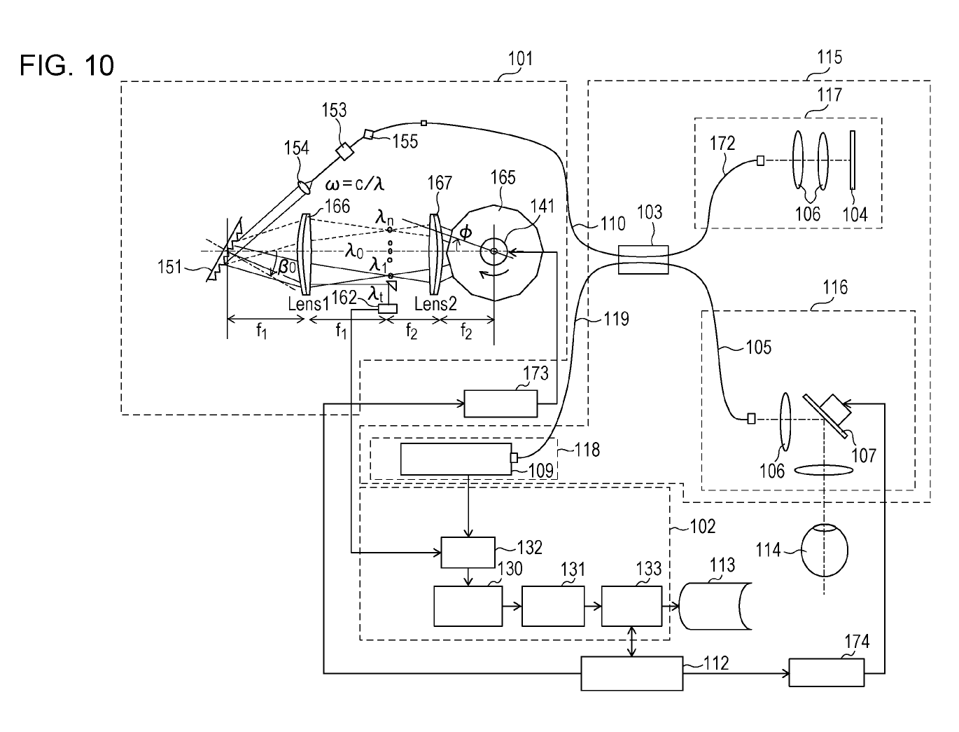

FIG. 10 schematically illustrates an optical coherence tomographic imaging apparatus according to a fourth embodiment.

The optical coherence tomographic imaging apparatus of the fourth embodiment is different from the apparatuses of the first to third embodiments in that a polygonal mirror is used as a wavelength selection mechanism in a light source unit 101, instead of the rotating disk.

In the fourth embodiment, as illustrated in FIG. 10, afocal converters 166 and 167 and a polygonal mirror 165 are provided on a downstream side of a diffraction grating 151. That is, a rotatable polygonal mirror is used as a wavelength selection element including a rotating mechanism, and two lenses functioning as collimator lenses are provided between the diffraction grating 151 and the polygonal mirror 165.

Similarly to the first embodiment, the wavelength is swept according to the rotation angle Φ of the polygonal mirror 165. Here, a reference wavelength λo is selected when Φ=0.

When βo represents the angle formed between the normal to a surface of the diffraction grating 151 and the optical axis of light with the reference wavelength λo, as illustrated in FIG. 10, it is understood that a light beam diffracted at an emergent angle β and the rotation angle Φ of the polygonal mirror 165 have the relationship expressed by the following Expression (14):

$$tan ( β - {β}_{0} ) = \frac{{f}_{2}}{{f}_{1}} tan φ \qquad ( 14 )$$

where f₁ and f₂ represent focal lengths of two lenses (lenses 166 and 167 in FIG. 10).

In contrast, in the case of a reflective diffraction grating, the relationship expressed by the following Expression (15) is known:

sin α+sin β=Nmλ (15)

where α represents the incident angle on the diffraction grating 151, N represents the groove number density on the diffraction grating 151 and is the reciprocal of the grating pitch, and m is a diffraction order of ±1, ±2, . . . , similarly to Expression (1). Here, m is set at +1. The angle in the counterclockwise direction around the normal to the diffraction grating 151 is a positive angle, and the angle in the clockwise direction is a negative angle.

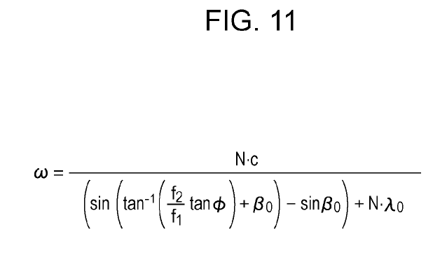

As illustrated in FIG. 11, the following Expression (16) is obtained from Expressions (14) and (15):

$$\begin{matrix}ω ( φ ) = \frac{c}{λ ( φ )} \\ = \frac{c}{{λ}_{0} + Δλ ( φ )}\end{matrix} \qquad ( 16 )$$

Thus, the following Expression (17) is obtained.

$$Δλ ( φ ) = \frac{1}{N} ( sin ( {tan}^{- 1} ( \frac{{f}_{2}}{{f}_{1}} tan φ ) + {β}_{0} ) - sin {β}_{0} ) \qquad ( 17 )$$

Expression (16) demonstrates the relationship between the rotation angle Φ of the polygonal mirror 165 and the selected optical frequency ω. Similarly to the first to third embodiments, when the polygonal mirror 165 rotates at constant speed, light interfering signals sampled at equal time intervals are temporarily stored in a storage functional portion 132 together with signals from a sweep-period trigger detector 162.

After the rotation angle is converted into the optical frequency according to Expression (16) by a functional portion 130, a data string of light interfering signals sampled at equal optical frequency intervals is created by interpolation with a processing functional portion 131.

By subjecting the data string of light interfering signals to FFT, an optical coherence tomographic image (image) with a high S/N ratio is obtained.

Initial adjustment of the sweeping period trigger is performed similarly to the first embodiment.

For example, it is assumed that the number of data points in one sweep is 2048 and the origin (Φ=0) of the rotation angle Φ is on the 1024-th point in the storage functional portion 132. A light interfering signal is moved in the storage functional portion 132 so that a reference wavelength λo is located at the 1024-th point.

A test body (object to be measured) 114 is replaced with a simulation sample having a mirror movable on the optical axis and a depth structure.

The initial value of Φ is obtained by moving the light interfering signal in the storage functional portion 132 so that the layer boundary becomes sharpest and the S/N ratio becomes high, while viewing an optical coherence image (image) obtained by subjecting light interfering signals converted at equal optical frequency intervals to FFT.

From the above, the reference wavelength λo can be located at the 1024-th point in the storage functional portion 132, and an optical coherence tomographic image (image) with a high S/N ratio can be obtained.

### Fifth Embodiment

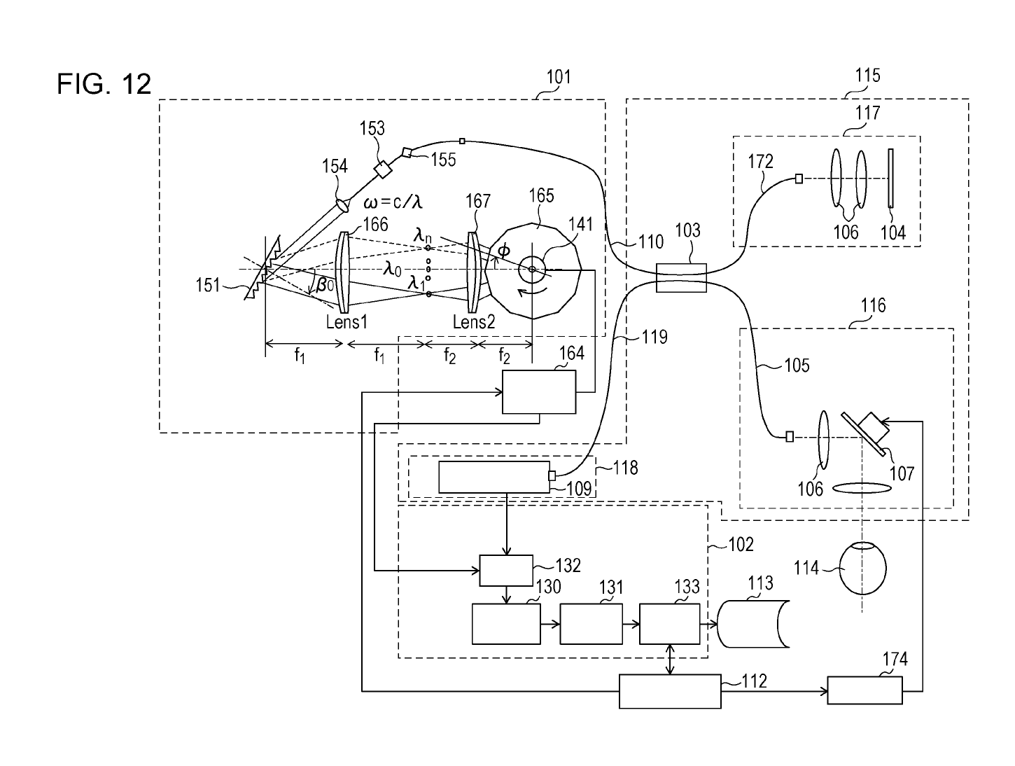

FIG. 12 schematically illustrates an optical coherence tomographic imaging apparatus according to a fifth embodiment.

The fifth embodiment is different from the fourth embodiment in that a rotation angle sensor 164 is installed instead of the trigger system for specifying the wavelength position of the light interfering signal.

Since the rotation angle sensor 164 directly detects the rotation angle Φ of a polygonal mirror 165, optical frequency conversion can be accurately performed according to Expressions (16) and (17).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-163548 filed Jul. 24, 2012, which is hereby incorporated by reference herein in its entirety.

What is claimed is:

1. An optical coherence tomographic imaging apparatus comprising:
a light source unit having a wavelength-sweeping light source configured to periodically change an oscillation wavelength of light;
an interference optical system configured to separate the light emitted from the light source unit into irradiation light for a test body and reference light and to generate interfering light between reflected light from the test body and the reference light;
a photo-detecting unit configured to detect an interfering signal of the interfering light; and an arithmetic processing unit configured to obtain a tomographic image of the test body on the basis of an intensity of the interfering signal detected by the photo-detecting unit,
wherein the wavelength-sweeping light source includes an optical resonator in which a light amplifying medium and a dispersive element configured to give angular dispersion to light emitted from the light amplifying medium according to a wavelength are provided, and a wavelength selection element having a rotating mechanism, and
wherein the arithmetic processing unit converts a selected wavelength obtained in correspondence with a rotation angle Φ of the rotating mechanism into an optical frequency ω, and obtains a data string of interfering signals at equal optical frequency intervals by interpolation on the basis of data on the interfering signals sampled in correspondence with the rotation angle Φ.

2. The optical coherence tomographic imaging apparatus according to claim 1, wherein the dispersive element is a diffraction grating.

3. The optical coherence tomographic imaging apparatus according to claim 1, wherein the optical frequency ω satisfies the following expression (10):
$$ω ( φ ) = \frac{c}{{λ}_{0} + Δλ ( φ )} \qquad ( 10 )$$
where λo represents a predetermined reference wavelength, Δλ(Φ) represents a change amount of the oscillation wavelength depending on the rotation angle Φ, and c represents a light speed.

4. The optical coherence tomographic imaging apparatus according to claim 3, wherein the wavelength selection element having the rotating mechanism includes a plurality of reflective members arranged on a circumference at an equal distance from a rotation center of a rotating disk.

5. The optical coherence tomographic imaging apparatus according to claim 4, wherein a condenser lens is provided between the dispersive element and the wavelength selection element including the rotating disk.

6. The optical coherence tomographic imaging apparatus according to claim 5, wherein a light beam dispersed according to the wavelength is made incident on the rotating disk by the dispersive element.

7. The optical coherence tomographic imaging apparatus according to claim 6, wherein the change amount Δλ(Φ) of the oscillation wavelength depending on the rotation angle Φ satisfies the following expression (13):
$$Δλ ( φ ) = \frac{1}{N} sin ( {tan}^{- 1} ( \frac{{r}_{0} tan φ - δ x}{{f}_{f}} ) + {sin}^{- 1} ( \frac{{λ}_{0}}{2} N ) ) - \frac{{λ}_{0}}{2} \qquad ( 13 )$$
where N represents a groove number density in the dispersive element, f_{f} represents a focal length of the condenser lens, δx represents a distance between an incident position of the predetermined reference wavelength λo on the rotating disk and a position at which the rotation center of the rotating disk is projected in a dispersion direction in which the dispersed light beam is incident.

8. The optical coherence tomographic imaging apparatus according to claim 2, wherein the wavelength selection element having the rotating mechanism uses a rotatable polygonal mirror.

9. The optical coherence tomographic imaging apparatus according to claim 8, wherein two lenses functioning as collimator lenses are provided between the diffraction grating and the polygonal mirror.

10. The optical coherence tomographic imaging apparatus according to claim 9, wherein the change amount Δλ(Φ) of the oscillation wavelength depending on the rotation angle Φ satisfies the following expression:
$$Δλ ( φ ) = \frac{1}{N} ( sin ( {tan}^{- 1} ( \frac{{f}_{2}}{{f}_{1}} tan φ ) + {β}_{0} ) - sin {β}_{0} ) \qquad ( 17 )$$
where N represents a groove number density in the diffraction grating, f₁ and f₂ represent focal lengths of the two lenses, and βo represents an angle formed between a normal to a grating surface of the diffraction grating and the predetermined reference wavelength λo.

11. An optical coherence tomographic imaging apparatus comprising:
a light source unit having a wavelength-sweeping light source configured to periodically change an oscillation wavelength of light;
an interference optical system configured to separate the light emitted from the light source unit into irradiation light for a test body and reference light and to generate interfering light between reflected light from the test body and the reference light;
a photo-detecting unit configured to detect an interfering signal of the interfering light; and an arithmetic processing unit configured to obtain a tomographic image of the test body on the basis of an intensity of the interfering signal detected by the photo-detecting unit,
wherein the wavelength-sweeping light source includes an optical resonator in which a light amplifying medium and a dispersive element configured to give angular dispersion to light emitted from the light amplifying medium according to a wavelength are provided, and a wavelength selection element having a mechanism configured to rotate at a constant speed, and
wherein the arithmetic processing unit converts a selected wavelength obtained in correspondence with a rotation angle Φ of the rotating mechanism into an optical frequency ω, and obtains a data string of interfering signals at equal optical frequency intervals by interpolation on the basis of data on interfering signals sampled at equal time intervals.
